(19) United States
(12) Patent Application Publication
(10) Pub. No.: US 2019/0054834 A1
(43) Pub. Date: Feb. 21, 2019

(54) ELECTRIC VEHICLE FURNISHED WITH COMMUNICATION NETWORK

(71) Applicant: BLUEBUS, Ergue Gaberic (FR)

(72) Inventors: Christophe BARDOT, Montigny Le Bretonneux (FR); Alain ROCHAIS, Plaisir (FR)

(21) Appl. No.: 15/570,953

(22) PCT Filed: Nov. 9, 2016
(86) PCT No.: PCT/EP2016/077101

§ 371 Date: Oct. 31, 2017

(30) Foreign Application Priority Data
Nov. 16, 2015 (FR) 1560968

(51) Int. Cl. B60L 11/18; H04L 12/40

(52) U.S. Cl. CPC B60L 11/1838; H04L 2012/40273; H04L 2012/40215; H04L 12/40

(57) ABSTRACT

An electric vehicle is provided, equipped with a communication network including:
at least one communication bus, called main communication bus; and
at least two subnetworks, each subnetwork carrying out a communication with at least two components of the vehicle;
each subnetwork including a communication node connecting the subnetwork to the main bus; and
the communication network includes a subnetwork dedicated to communicating with the rechargeable electrical energy storage modules.

The present invention relates to an electric vehicle equipped with a communication network.

The field of the invention is the field of communication networks for electric vehicles.

### BACKGROUND

Vehicles, and in particular electric vehicles that can be recharged from an external electrical energy source, comprise various components which have to communicate with each other or with external recharging stations in order to ensure the correct operation of said vehicle.

In addition, the number of sensors fitted in current vehicles continues to increase. These sensors communicate with the components of the vehicle and/or with the driver of the vehicle in order to ensure the correct operation and safety of the vehicle.

For these reasons, the quantity of data items exchanged within the vehicle, but also between the vehicle and devices external to the vehicle, continuously increases. In order to ensure these exchanges of data items, current vehicles are equipped with a communication network which is becoming increasingly complex.

However, current communication networks fitted in vehicles are not very flexible, so that adapting them to the different applications of one and the same vehicle is complex. In addition, current communication networks fitted in vehicles are not very upgradable. Therefore, when the electrical architecture of a vehicle is upgraded over time, it is sometimes necessary to modify a large portion, or even the entirety, of the architecture of the communication network fitted in said vehicle. These drawbacks are amplified in the context of rechargeable electric vehicles, which require greater communication between the different components of the vehicle, due, for example, to management of the electrical energy within the vehicle.

A purpose of the present invention is to overcome these drawbacks.

A further purpose of the invention is to propose an electric vehicle equipped with a communication network that is more flexible than the communication networks of current vehicles.

Yet a further purpose of the invention is to propose an electric vehicle equipped with a communication network that is more upgradable than the communication networks of current vehicles.

### SUMMARY OF THE INVENTION

The invention makes it possible to achieve at least one of these aims by means of an electric vehicle equipped with a communication network comprising:
at least one communication bus, called main communication bus; and
at least two subnetworks, each subnetwork carrying out communication with at least two components of said vehicle;
   each subnetwork comprising a communication node connecting said subnetwork to said main bus.

Thus, the invention proposes to use, in an electric vehicle, a communication network organised in subnetworks with respect to a main communication bus carrying data items to/from these subnetworks. This communication network architecture makes it possible to modify or to upgrade one of the subnetworks depending on the desired application in the vehicle or depending on the vehicle upgrade, without having to modify the rest of the communication network. For example, a communication subnetwork can be associated with the transmission of data items to/from the components of a driver's cab. When the driver's cab is modified in order to be adapted to a specific application, or following an upgrade, only this subnetwork is modified, without having to intervene in the rest of the communication network. Thus, the communication network of the vehicle according to the invention is more flexible and more upgradable than the communication networks of current vehicles.

According to the invention, each subnetwork operates independently from the other subnetworks.

Advantageously, at least one subnetwork can comprise at least one communication bus, called secondary communication bus, connecting several components of said vehicle to the communication node of said subnetwork.

Such a subnetwork is flexible and upgradable so that each modification, such as adding or removing, or also upgrading, at least one component connected to said secondary communication bus can be carried out in a simple, quick, and uncomplicated manner and independently of the other components connected to said secondary bus.

Advantageously, at least one communication bus, i.e. the main bus and/or at least one secondary bus, can be a multiplexed communication bus, preferentially of the CAN (Controller Area Network) type.

Advantageously, in at least one subnetwork, the communication node can be connected to at least one component of said vehicle by a communication link dedicated to said component, i.e. by a point-to-point connection.

Such a point-to-point connection with the communication node can for example be used for components that are of greater importance with respect to the other components.

In addition, in at least one subnetwork, at least one component of said vehicle can be connected to the communication node of said subnetwork via another component of said vehicle.

Such another component forms a communication gateway between said component and the communication node.

Of course, in at least one subnetwork, the communication node can be connected:
to several components of the vehicle via a communication bus,
to at least one component of the vehicle via a point-to-point connection, and/or
to at least one component of the vehicle via another component of the vehicle.

In addition, the main communication bus can be arranged so that at least one component of said vehicle can be directly connected to said main communication bus, such as a telemetry component and/or an electrical power conversion component.

According to an embodiment, at least one, in particular each, communication node can be a dedicated module/appliance. This architecture makes it possible to make the communication network even more flexible and upgradable.

Alternatively or in addition, at least one, in particular each, communication node can be incorporated in a component of said vehicle. This architecture makes it possible to reduce the number of components forming the communication network, and therefore its cost and bulk.

According to a particularly preferred embodiment, at least one, in particular each, subnetwork can carry out communication with the components of the vehicle dedicated to a predetermined function, or forming a predetermined functional group.

For example, the communication network can comprise:
a subnetwork dedicated to communicating with the rechargeable electrical energy storage modules,
a subnetwork dedicated to communicating with the components comprising a power train,
a subnetwork dedicated to communicating with the user interface components, and/or
a subnetwork dedicated to communicating with the operational auxiliary components of said vehicle, such as openings, one or more compressors, etc.

The vehicle according to the invention can for example be an electric public transport land vehicle, of the bus, coach or tyred tram type.

In the present application, a “tyred tram” denotes an electric public transport land vehicle mounted on wheels and which is recharged at each station, so that it has no need for heavy infrastructures of the tracks or catenaries type on the road system. Such an electric vehicle is recharged at each station by means of charging elements of the station and a connector connecting said vehicle to said station.

According to the invention, the vehicle can comprise one or more rechargeable electrical energy storage modules. Each module can comprise one or more batteries. Each of the batteries can advantageously be or comprise at least one Lithium-metal-polymer battery, also called “LMP®” battery, or a supercapacitor.

### DESCRIPTION OF THE FIGURES AND EMBODIMENTS

Other advantages and characteristics will become apparent on examination of the detailed description of embodiments which are in no way limitative, and the attached diagrams, in which:

FIG. 1 is a diagrammatic representation of a non-limitative example of a communication network of a vehicle according to the invention; and

FIGS. 2-5 are diagrammatic representations of subnetworks forming part of the communication network in FIG. 1.

It is well understood that the embodiments which will be described hereinafter are in no way limitative. In particular, it is possible to envisage variants of the invention comprising only a selection of the characteristics described hereinafter, in isolation from the other characteristics described, if this selection of characteristics is sufficient to confer a technical advantage or to differentiate the invention with respect to the state of the art. This selection comprises at least one, preferably functional, characteristic without structural details, or with only a part of the structural details if this part alone is sufficient to confer a technical advantage or to differentiate the invention with respect to the state of the art.

In the figures, components common to several figures retain the same reference.

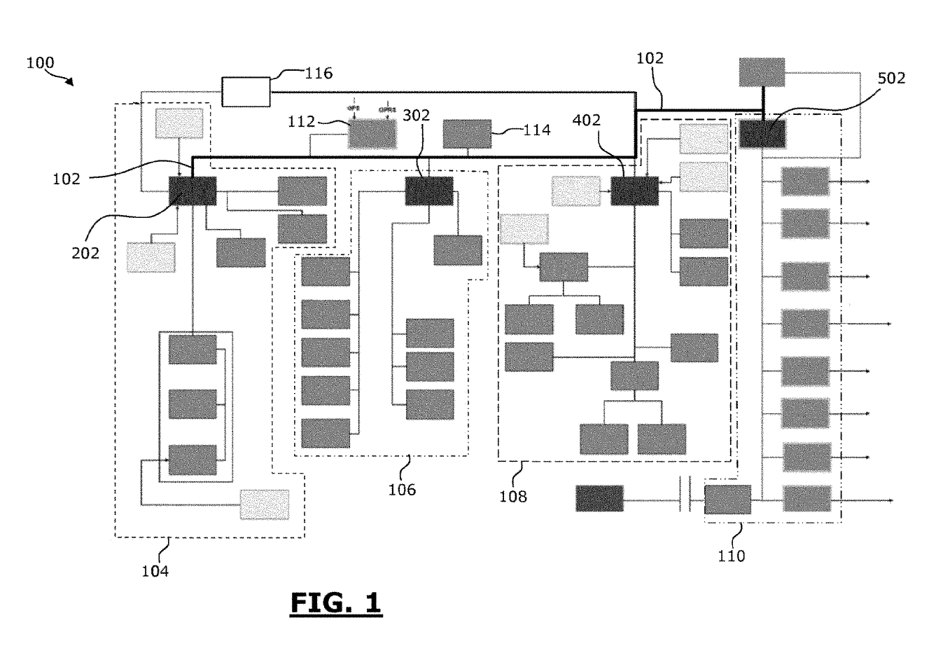

FIG. 1 is a diagrammatic representation of a non-limitative embodiment of a communication network of an electric vehicle according to the invention.

The communication network 100 shown in FIG. 1 comprises a main communication bus 102.

The communication network 100 also comprises four subnetworks, 104-110 respectively, connected to the main bus 102 via a communication node. Each subnetwork 104-110 makes it possible to communicate with several components of the vehicle in one- or two-way communication.

Furthermore, the communication network comprises communication links connecting the main communication bus 102 directly to one or more components of the vehicle, such as:
a telemetry component 112 connected for example to a geolocation means of the GPS type or a wireless communication means of the GPRS type;
an electrical power transformation component 114, such as for example a 400V→24V voltage converter;
an optional component 116 corresponding to an option desired by the user of the vehicle, or required by an application to which the vehicle is dedicated;
etc.

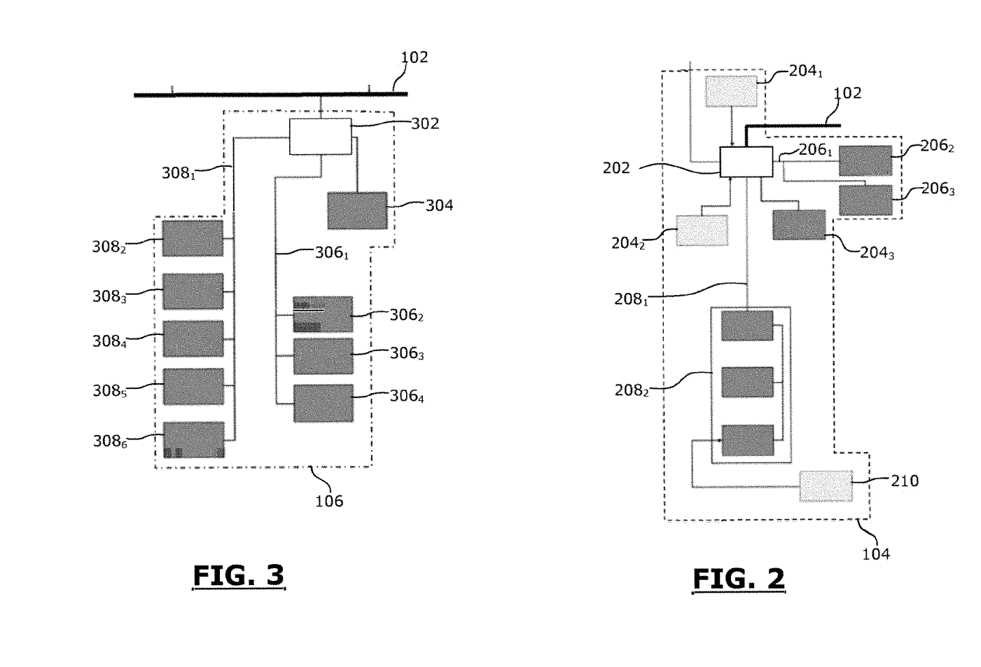

The different subnetworks 104-110 will now be described with reference to FIGS. 2-5.

FIG. 2 is a diagrammatic representation of an example of a subnetwork capable of forming part of a communication network according to the invention.

In particular, the subnetwork represented in FIG. 2 corresponds to the subnetwork 104 in FIG. 1.

The subnetwork 104 comprises a communication node 202 making it possible for each of the components forming part of the subnetwork 104 to communicate with each other and/or to access the main communication bus 102.

The subnetwork 104 contains the components 204₁-204₃, which are connected to the communication node 202 using a point-to-point connection. The component 204₁ can correspond to a speed sensor, the component 204₂ can correspond to the steering column module comprising the controls relating to the windscreen wipers, the lights/headlamps etc., and the component 204₃ can correspond to the rain/light sensors.

The subnetwork 104 can comprise a secondary communication bus 206₁ located in the subnetwork 104 and connecting the components 206₂ and 206₃ to the communication node 202. The component 206₂ can correspond to the power steering of the vehicle and the component 206₃ to an electronic SAS (Steering Angle Sensor) box of the vehicle for measuring the angle of the steering wheel of the vehicle.

The subnetwork 104 contains a connection link 208₁ connecting a box of components 208₂, which can be actuator buttons, also called “switches”, provided in the driver's cab in order to operate the doors of the vehicle, the heating, the ventilation, the lighting etc., to the communication node 202.

Furthermore, the subnetwork 104 contains a component 210, which can for example be an EPB (Electronic Parking Break) lever, connected to the communication node 202 via the switch box 208₂. In other words, the switch box 208₂ forms a gateway between the component 210 and the communication node 202.

As described, the subnetwork 104 makes it possible to communicate with the components of the vehicle forming part of a driver interface of the vehicle. Therefore, when an element is added to this driver interface, or an element of the driver interface is modified, only the communication subnetwork 104 requires intervention from an operator. Such an addition or such a modification does not have an impact on the rest of the communication network 100.

FIG. 3 is a diagrammatic representation of another example of a subnetwork capable of forming part of a communication network according to the invention.

In particular, the subnetwork represented in FIG. 3 corresponds to the subnetwork 106 in FIG. 1.

The subnetwork 106 comprises a communication node 302 making it possible for each of the components forming part of the subnetwork 106 to communicate with each other and/or to access the main communication bus 102.

The subnetwork 106 contains a component 304 which is connected to the communication node 302 using a point-to-point connection. The component 304 can correspond to an air compressor of the electric vehicle.

The subnetwork 106 can comprise a secondary communication bus 306₁ located in the subnetwork 106 and connecting the components 306₂-306₄ to the communication node 302. Each of the components 306₂-306₄ can correspond to an opening, and in particular to a door, of the electric vehicle.

The subnetwork 106 can comprise a second secondary communication bus 308₁ located in the subnetwork 106, independent of the secondary communication bus 306₁ and connecting the components 308₂-308₆ to the communication node 302. Each of the components 308₂-308₆ can correspond to the auxiliary components ensuring ventilation, lights, heating etc. of the vehicle.

As described, the subnetwork 106 makes it possible to communicate with the operational components of the vehicle, such as the openings, the compressor etc. Therefore, when an operational component is added to the vehicle, or an operational component of the vehicle is modified, only the communication subnetwork 106 requires intervention from an operator. Such an addition or such a modification does not have an impact on the remainder of the communication network 100.

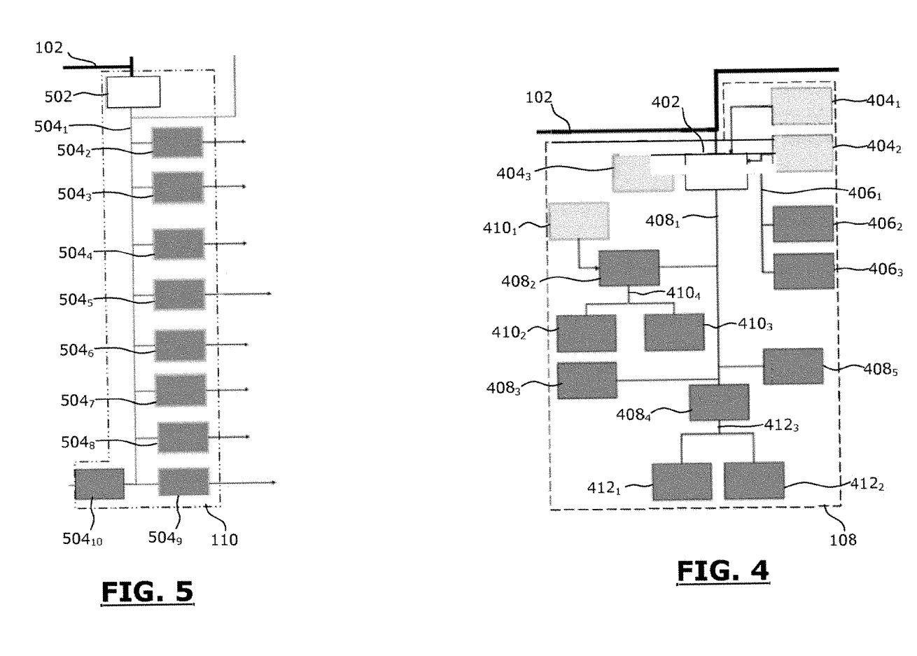

FIG. 4 is a diagrammatic representation of another example of a subnetwork capable of forming part of a communication network according to the invention.

In particular, the subnetwork represented in FIG. 4 corresponds to the subnetwork 108 in FIG. 1.

The subnetwork 108 comprises a communication node 402 making it possible for each of the components forming part of the subnetwork 108 to communicate with each other and/or to access the main communication bus 102.

The subnetwork 108 contains the components 404₁-404₃, which are connected to the communication node 402 using a point-to-point connection. The components 404₁ and 404₂ can correspond to temperature sensors of the power train of the vehicle and the component 404₃ to an accelerator pedal of the vehicle.

The subnetwork 108 can comprise a first secondary communication bus 406₁ located in the subnetwork 108 and connecting the components 406₂ and 406₃ to the communication node 402. The components 406₂ and 406₃ can correspond to the water pumps of the power train of the vehicle.

The subnetwork 108 can comprise a second secondary communication bus 408₁ located in the subnetwork 108 and connecting the components 408₂-408₅ to the communication node 402. The components 408₂-408₅ are the components of the vehicle which form part of the power train of said vehicle. For example, the component 408₂ can correspond to a braking module of the EBS type, the component 408₃ can correspond to the suspension system etc.

Furthermore, the subnetwork 108 contains the components 410₁-410₃ connected to the communication node 402 via the component 408₂. In other words, the EBS braking module 408₂ can form a communication gateway, i.e. a switch, between the components 410₁-410₃ and the communication node 402. The components 410₁-410₃ can be components which intervene in the braking operation of the vehicle.

At least one of the components 410₁-410₃ can only communicate with component 408₂ without communicating with the communication node 402.

Alternatively or in addition, at least one of the components 410₁-410₃ can only communicate with at least one of the other components 410₁-410₃ without communicating with the communication node 402.

In addition, the components 410₂-410₃ are connected to the component 408₂ via another secondary bus 410₄ only located between the components 410₂-410₃ and the component 408₂.

Furthermore, the subnetwork 108 contains the components 412₁ and 412₂ connected to the communication node 402 via the component 408₄. In other words, the component 408₄ can form a communication gateway between the components 412₁ and 412₂ and the communication node 402.

The components 412₁ and 412₂ can, alternatively, communicate with each other and/or with the module 408₄ without communicating with the communication node 402.

The components 412₁ and 412₂ are connected to the component 408₄ via another secondary bus 412₃ only located between the components 412₁ and 412₂ and the component 408₂.

As described, the subnetwork 108 makes it possible to communicate with the components involved in the power train of the vehicle. Therefore, when a component is added to the power train, or a component of the power train is modified, only the communication subnetwork 108 requires intervention from an operator. Such an addition or such a modification does not have an impact on the remainder of the communication network 100.

FIG. 5 is a diagrammatic representation of another example of a subnetwork capable of forming part of a communication network according to the invention.

In particular, the subnetwork represented in FIG. 5 corresponds to the subnetwork 110 in FIG. 1.

The subnetwork 110 comprises a communication node 502 making it possible for each of the components forming part of the subnetwork 110 to communicate with each other and/or to access the main communication bus 102.

The subnetwork 110 contains a secondary communication bus 504₁ located in the subnetwork 110 and connecting the components 504₂-504₁₀ to the communication node 502. The components 504₂-504₉ can correspond to rechargeable electric storage modules, such as batteries or supercapacitors. The component 504₁₀ can correspond to a management box of each of the storage modules 504₂-504₉.

As described, the subnetwork 110 makes it possible to communicate with the electrical energy storage components in the vehicle. Therefore, when an electrical energy storage component is added, or is modified, only the communication subnetwork 110 requires intervention from an operator. Such an addition or such a modification does not have an impact on the remainder of the communication network 100.

At least one of the communication nodes 202, 302, 402 and 502 can be an additional box dedicated only to communication. Alternatively, at least one of the communication nodes 202, 302, 402 and 502 can be incorporated in an existing component/module/box carrying out at least one other operation in the vehicle.

Of course, the invention is not limited to the examples detailed above, the number and/or the architecture and/or the operational group with which a subnetwork/subnetworks is/are associated can be different. In addition, the communication network can comprise a subnetwork associated with an operational group different from those indicated by way of example.

1. An electric vehicle equipped with a communication network comprising:
at least one communication bus, called main bus;
at least two subnetworks, each subnetwork carrying out a communication with at least two components of said vehicle;
each subnetwork comprising a communication node connecting said subnetwork to said main bus; and
said communication network comprises a subnetwork dedicated to communicating with the rechargeable electrical energy storage modules.

2. The vehicle according to claim 1, characterized in that at least one subnetwork comprises a communication bus, called secondary bus, connecting several components of said vehicle to the communication node of said subnetwork.

3. The vehicle according to claim 1, characterized in that at least one communication bus is a multiplexed communication bus of the CAN (Controller Area Network) type.

4. The vehicle according to claim 1, characterized in that, in at least one subnetwork, the communication node is connected to at least one component of said vehicle via a communication link dedicated to said component, i.e. by a point-to-point connection.

5. The vehicle according to claim 1, characterized in that, in at least one subnetwork, at least one component of said vehicle is connected to the communication node of said subnetwork via another component of said vehicle.

6. The vehicle according to claim 1, characterized in that at least one component of said vehicle is connected directly to the main communication bus, such as a telemetry component and/or an electrical power conversion component.

7. The vehicle according to claim 1, characterized in that at least one, in particular each, subnetwork carries out a communication with the components of the vehicle dedicated to a predetermined operation.

8. The vehicle according to claim 1, characterized in that at least one, in particular each, communication node is incorporated in a component of said vehicle.

9. The vehicle according to claim 1, characterized in that the communication network comprises:
a subnetwork dedicated to communicating with the components making up a power train, and/or
a subnetwork dedicated to communicating with the user interface components, and/or
a subnetwork dedicated to communicating with the operational auxiliary components of said vehicle.

10. The vehicle according to claim 1, characterized in that it is an electric public transport land vehicle of the bus, coach or tyred tram type.
